(19) United States
(12) Patent Application Publication
(10) Pub. No.: US 2008/0147417 A1
(43) Pub. Date: Jun. 19, 2008

(54) Systems and Methods for Automated Weather Risk Assessment

(76) Inventor: David Friedberg, San Francisco, CA (US)

Correspondence Address: CARR & FERRELL LLP, 2200 GENG ROAD, PALO ALTO, CA, 94303, US

(21) Appl. No.: 11/611,111

(22) Filed: Dec. 14, 2006

(51) Int. Cl. G06Q 99/00

(52) U.S. Cl. 705/1

(57) ABSTRACT

A system and method for automated weather risk assessment is provided. A user is queried for business specific data. The business specific data is received from the user. A weather risk is then automatically assessed utilizing historical weather data over a period of time based on the business specific data. The weather risk is reported to the user.

### CROSS-REFERENCE TO RELATED APPLICATIONS

The present application is related to U.S. Patent Application No. ______ filed Dec. 1, 2006 entitled “Single Party Platform for Sale and Settlement of OTC Derivatives,” and U.S. Patent Application No. ______ filed Dec. 1, 2006 entitled “System and Method for Creating Customized Derivatives,” both of which are herein incorporated by reference.

### BACKGROUND OF THE INVENTION

1. Field of the Invention

The present invention relates generally to financial risk analysis, and more particularly to systems and methods for automated weather risk assessment.

2. Description of Related Art

Conventionally, weather derivatives represent financial instruments based on weather related events. Purchasers often buy weather derivatives to manage weather-related risk. For example, beverage sales and agriculture related industries may buy weather derivatives to insure against weather related revenue losses.

Weather derivatives can also hedge revenue loss through an over-the-counter wholesale market and the availability of custom-structured weather products. Weather can negatively impact revenues, increase inventory costs, or lead to volatility in input. The use of weather derivatives can help to reduce the impact that adverse weather may have on a company's bottom line. These weather conditions can be managed utilizing various customized weather indexes tailored to specific customer needs, including heating and cooling degree days, precipitation, snowfall, wind, and sunlight hours.

Unfortunately, processes for determining weather related risk associated with specific industries or companies are typically imprecise, difficult to find, and cryptic to operate. Accordingly, companies often pay for weather derivatives that don't necessarily correlate realistically with revenue loss risks associated with the companies.

Although different weather stations and indexes exist, determining which information to utilize to assess particular risks can be challenging. Generally, companies can access information regarding the weather elements that most affect the companies. Specific information about specific risks tailored to specific companies, however, is not readily available.

### SUMMARY OF THE INVENTION

The present invention provides a system and method for automated weather risk assessment. In exemplary embodiments, a user is queried for business specific data and a location for where that data applies. The business specific data is received from the user. A weather risk is then automatically assessed utilizing historical weather data over a period of time based on the business specific data. The weather risk is reported to the user.

### BRIEF DESCRIPTION OF THE DRAWINGS

FIG. 1 illustrates a schematic diagram of an exemplary environment for automated weather risk assessment;

FIG. 2 illustrates a block diagram of an exemplary weather risk assessment engine;

FIG. 3 illustrates a flow diagram of an exemplary process for assessing weather risk based on the business specific data comprising financial data;

FIG. 4 shows a flow diagram of an exemplary process for automatically assessing risk based on estimated data from the user; and

FIG. 5 illustrates a flow diagram of an exemplary process for automated risk assessment.

### DETAILED DESCRIPTION

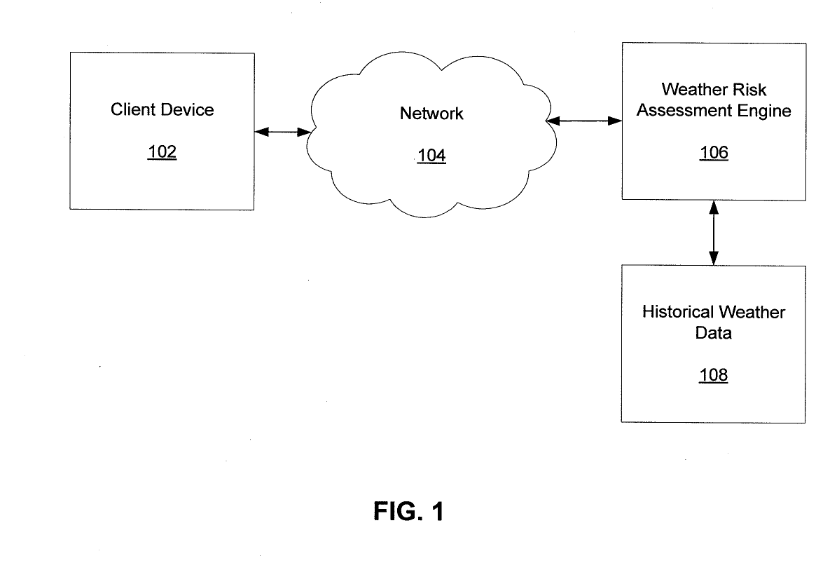

FIG. 1 illustrates a schematic diagram of an exemplary environment for automated weather risk assessment. A client device 102 communicates over a network 104 with a weather risk assessment engine 106. The weather risk assessment engine 106 is in communication with historical weather data 108. The historical weather data 108 may be provided by a weather station, a database of historical weather data, and so forth. For example, information from a station owned and operated by the National Weather Service or a third party that processes National Weather Service data may be utilized for the historical weather data 108 and/or current weather data. Any type of storage medium or resource may provide the historical weather data 108.

The client device 102 may comprise any device, such as a laptop or desktop computer, a cellular telephone, a personal digital assistant, and so forth. According to some embodiments, the client device 102 may communicate directly with the weather risk assessment engine 106. In one instance, the weather risk assessment engine 106 comprises an application resident on the client device 102.

The weather risk assessment engine 106 may comprise a software application, a server computer, or any other type of application or device capable of assessing weather risk. The client device 102 provides information to the weather risk assessment engine 106 via the network 104, according to exemplary embodiments. For example, business specific data may be provided to the weather risk assessment engine 106 via a question and answer process, a questionnaire, an accounting program, and so forth. Any type of business specific data may be provided to the weather risk assessment engine 106 by the client device 102.

The business specific data typically relates to a business, industry, company, and so forth associated with the client device 102. For example, a particular golf course may provide business specific data related to the particular golf course's business to the weather risk assessment engine via the client device 102. The weather risk assessment engine 106 then utilizes the business specific data and the historical weather data 108 to assess a weather risk for the particular golf course.

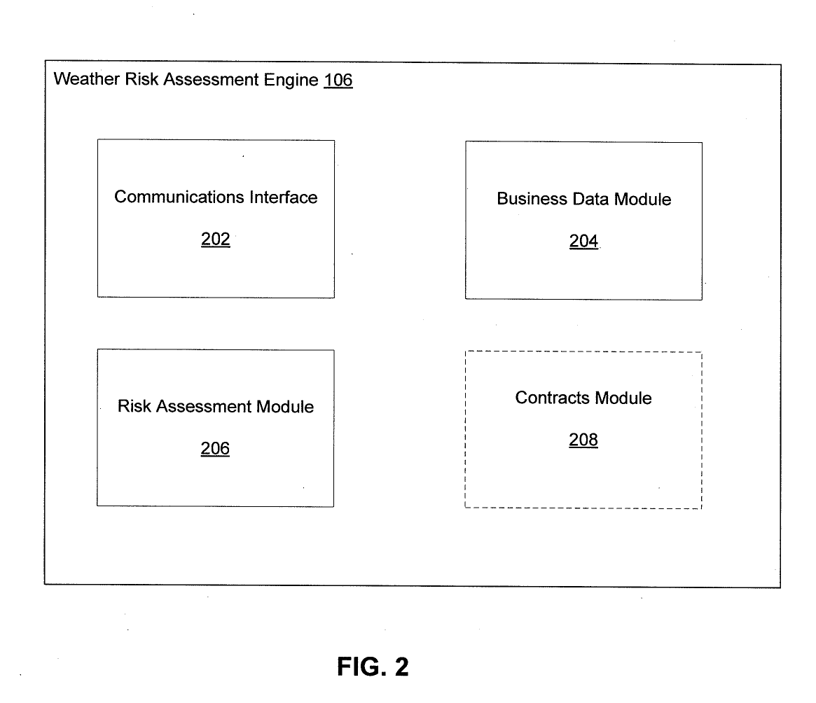

Referring now to FIG. 2, a block diagram of an exemplary weather risk assessment engine, such as the weather risk assessment engine 106 discussed in FIG. 1, is illustrated. The weather risk assessment may comprise a communications interface 202, a business data module 204, a risk assessment module 206, and an optional contract module 208. Although FIG. 2 illustrates the weather risk assessment engine 106 as comprised of these various modules, fewer or more modules may comprise the weather risk assessment engine 106 and still fall within the scope of various embodiments.

The communications interface 202 allows data to be exchanged between the weather risk assessment engine 106 and the client device 102. For example, the client device 102 may communicate business specific data, such as financial data from a data program, to the weather risk assessment engine 106 via the communications interface 202.

The business data module 204 receives the business specific data from the client device 102. The business data module 204 can store the business specific data according to some embodiments. Alternatively, the business data module 204 may be coupled to, or otherwise in communication with, a storage medium (not shown) for storing the business specific data from the client device 102.

Business specific data may comprise basic business data. For example, a user associated with the client device 102 may be asked to provide information regarding three variables, such as zip code, revenue, and business type. Any number of variables representing basic business data may be provided by the client device 102. In other words, the basic business data may represent fairly generic data about a specific business. The basic business data may be utilized to access data about other businesses of similar size, type, with similar revenues, similar location, and so forth.

The user can also provide business specific data by completing a questionnaire or otherwise providing answers to questions provided by the weather risk assessment engine 106. The user may be asked a series of detailed questions to help the weather risk assessment engine 106 determine the impact of weather on a business associated with the user, or associated with a person or entity represented by the user. For example, the user may be asked about income stream, types of income, seasonal influences, and so forth.

Another manner by which business specific data may be provided is via accounting records. For example, the user may upload a financial report generated by a Quickbooks™ application, or any alternative financial accounting application. Such financial information may also be provided from various types of data sources, including, but not limited to, spreadsheets, accounting programs, manually entered financial information, and so forth.

Although various options are discussed for providing business specific data, other options for providing business specific data may be provided according to other embodiments. For example, the user may provide income tax returns, stock reports, and so forth as the business specific data. Further, any combination of types of the business specific data described herein may be provided.

The risk assessment module 206 compares the business specific data to the historical weather data 108. Based on the comparison, the risk assessment module 206 determines exposure of a business and how the businesses performance is affected by weather. For example, the risk assessment module 206 may consider the mean, median, and standard deviation of the financial performance of the business for the last ten years to determine a risk level due to weather.

The weather risk assessment module 206 can output the weather risk assessment determined to the user. The weather risk assessment may be specific, such as a range of revenue loss that may be expected given the business specific data, the historical weather data 108, and/or future weather forecasts. The weather risk assessment can also be generalized, such as indicating on a scale the weather risk for the particular business being assessed. For example, the particular business may receive an output indicating that the particular business has a mid-level risk of experiencing revenue losses or increased costs according to the weather.

In other words, the weather risk assessment can be as general or detailed as desired. According to some embodiments, the user can specify how detailed the user wants the weather risk assessment. For example, the weather risk assessment can specify how much revenue is attributed to each day of rain over a certain amount for each year and project how much revenue loss may be experienced in future years for similar weather circumstances.

Optionally, the user can also provide business specific data related to insurance or other protections initiated to protect against weather related revenue loss. The business specific data related to the insurance or the other protections may be provided initially or in response to the weather risk assessment provided to the user. In the latter scenario, the risk assessment module 206 may reassess the weather risk considering measures such as the insurance and/or the other protections.

The optional contracts module 208 may store or access contracts or a list of contracts related to weather derivatives. The contracts module 208 can utilize the assessment from the risk assessment module 206 to recommend one or more contracts. For example, based on a temperature-related risk assessment, the contracts module 208 may recommend one or more temperature-based weather derivative contracts to protect the particular business against any potential weather related revenue losses.

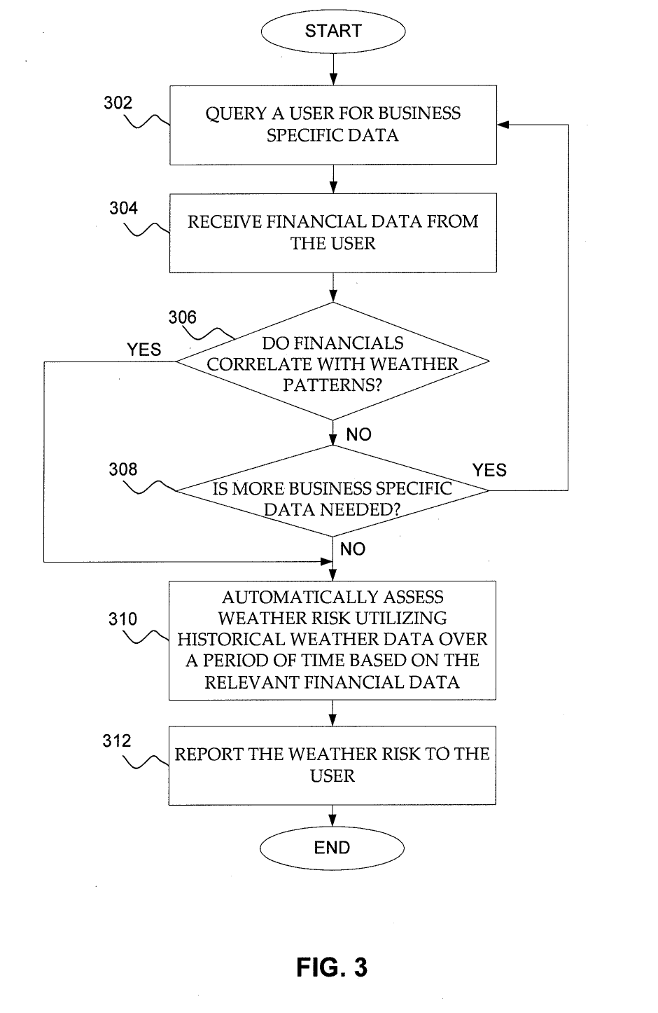

FIG. 3 illustrates a flow diagram of an exemplary process for assessing weather risk based on the business specific data comprising financial data. At step 302, the user is asked for financial data, such as a Quickbooks™ report. As discussed herein, any type of financial data from any finance (e.g., accounting) program or storage medium can be provided by the user.

At step 304, the financial data is received from the user. The financial data is uploaded to the weather risk assessment engine 106 according to exemplary embodiments. However, the financial data may be provided manually and entered by a user associated with the weather risk assessment engine, called in to a user associated with the weather risk assessment engine, provided on an electronic medium, such as a CD, and so forth. Any manner of providing the financial data to the weather risk assessment engine 106 is within the scope of various embodiments.

At step 306, the weather risk assessment engine 106 determines whether the financial data correlates with weather patterns. Statistical techniques, and non-financial data provided by the user, are utilized to estimate correlation and causality between the financial data and the historical weather data 108. In some cases, other events, unrelated to weather, may affect the financial performance of a particular business. The user may be optionally queried about specific financial data to help determine which items of the financial information are clearly not weather related. If the financial data correlates with weather patterns, the weather risk assessment engine 106 can automatically assess the weather risk as discussed in step 310. If the financial data does not correlate with weather patterns, a determination whether more business specific data is needed in step 308.

At step 308, the weather risk assessment engine 106 determines whether more business specific data is needed. If more business specific data is needed, such as events that may affect the financial data, non-financial data, and so forth, the user is queried for business specific data at step 302.

At step 310, a weather risk is automatically assessed utilizing the historical weather data 108 over a period of time based on the relevant financial data, if no additional business specific data is needed at step 308. In order to determine the weather risk, the weather risk assessment engine 106 utilizes the business specific data, such as from the business data module 204, and dates that the revenue associated with the business specific data is generated. For each temporal step of business data (e.g., daily, weekly, or other), the historical weather data 108 that correlates with that time period is accessed, such as from a third party that processes National Weather Service data. The revenue for the time period and the appropriate historical weather data 108 for the day is evaluated over a period of time and the weather risk assessment engine 106 determines sensitivities to weather, relationships to temperature and/or precipitation, and so forth. For example, a particular business may make $80 each day. The weather risk assessment may reveal that for everyday the temperature exceeds 75 degrees, the particular business loses $20.

At step 312, the weather risk is reported to the user. The weather risk may be reported in explanatory text, charts, graphs, and so forth. Any manner of reporting the weather risk is within the scope of various embodiments.

According to some embodiments, the user can select the weather station or other resource from which the historical weather data 108 is utilized. For example, the user may request the historical weather data 108 from a San Jose, Calif., weather station because although the zip code and address information from a business associated with the user indicates that the business is located in Santa Clara, Calif., the weather patterns in San Jose, Calif., affect the business most.

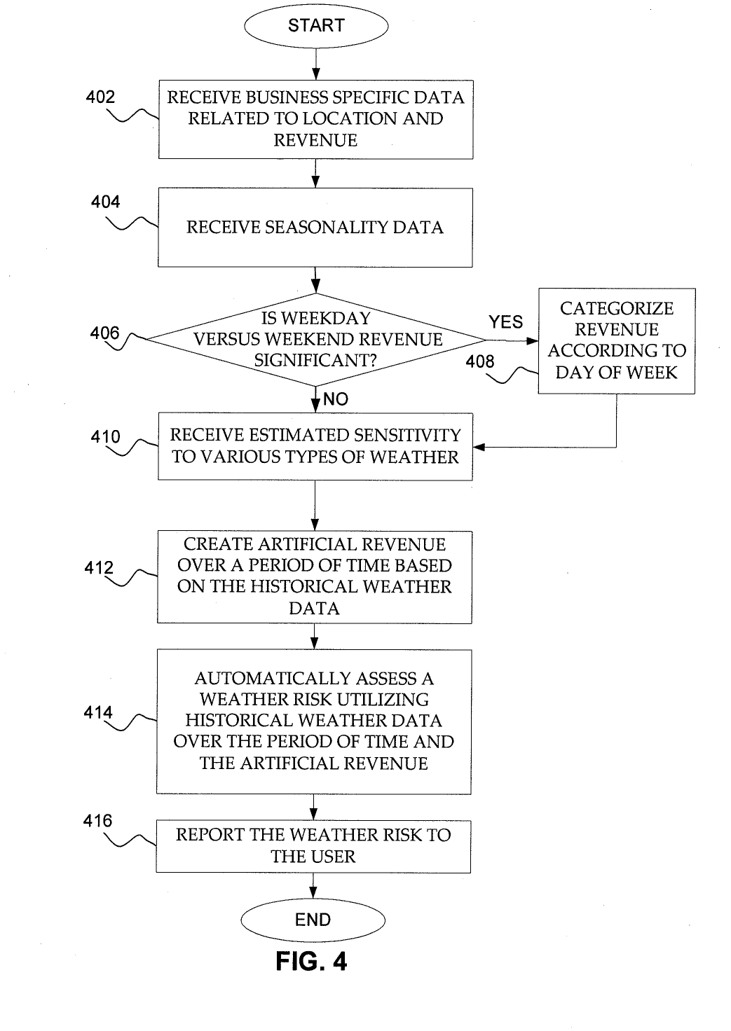

As discussed herein, the user may provide other types of business specific data other than, or in addition to, the financial data. FIG. 4 shows a flow diagram of a process for automatically assessing risk based on estimated data from the user.

At step 402, business specific data related to location and revenue is received from the user. The weather risk assessment engine 106 can query the user as to the location of a business for which the user desires a weather risk assessment and the revenue of the business. For example, the annual revenue for the business may be requested. The user can provide the annual revenue for any period of time.

At step 404, the user provides seasonality data related to the business. For example, the user can indicate what times of year are best for the business, such as the spring and summer months generate the most revenue for a business comprising a golf course. The user can provide the seasonality data based on days of the month, monthly, quarterly, yearly, and so forth.

At step 406, the weather risk assessment engine 106 determines whether the weekday versus weekend revenue is significant. For many businesses, either the weekend or the weekdays generate the majority of revenue. However, some businesses may not be affected by the day of the week.

If the weekday versus weekend revenue is significant, the revenue is categorized according to the day of the week at step 408. Accordingly, the weather risk assessment engine 106 can assess weather risks differently, if necessary. For example, if rain adversely affects the business, but little revenue is generated during heavy periods of rain anyway since most rain occurs during the week when the business generates the least amount of revenue, the weather risk assessment engine 106 can consider the day of the week revenue separately when assessing risks.

At step 410, the user estimates sensitivity to various types of weather. A slider, graph, or any other input medium may be provided for allowing the user to estimate the sensitivity. For example, the user may utilize a slider to indicate how the user estimates the business is affected by rain, temperature, snow, wind, and so forth.

At step 412, the weather risk assessment engine 106 generates artificial revenue(s) for the business based on the data received from the user. For example, the user may provide revenue data for the past two years. The weather risk assessment engine utilizes the actual revenue data provided and the other data received from the user to create an artificial revenue over a period of time, such as for the past ten years.

At step 414, the weather risk is automatically assessed by the weather risk assessment engine 106 utilizing the historical weather data 108 over the period of time, such as ten years, and the artificial revenue. For example, the weather risk assessment engine 106 may determine that on average, the business receives greater revenues when the temperature is above 65 degrees, but below 85 degrees.

At step 416, the weather risk is reported to the user. As discussed herein, a contract type may be recommended to the user by the contracts module 208 associated with the weather risk assessment engine 108 based on the weather risk reported, according to some embodiments. In other embodiments, weather derivative terms may be generated for the user by the contracts module 208. Such terms can represent an ideal contract to cover or hedge exposure to probable weather-related events. The user may subsequently purchase a weather derivative based on the weather derivative terms.

The weather risk may be reported with details about specific impacts on the business by specific weather types and/or weather patterns, the weather risk may reported as a general risk of low, medium, high, and so forth, and/or the weather risk may be reported as a percentage of the business that is impacted by weather. Any type of scale, details, percentages, comparisons to other businesses, and so forth may be utilized to report the weather risk to the user.

As discussed herein, any of the business specific data, such as the estimated data, the financial data, the basic business data, revenues, location, industry type, and so forth may be utilized to access data about similar businesses. The data about similar businesses may be utilized to help determine the weather risk. Further, the data about similar businesses may be utilized to indicate to the user how similar businesses are affected by weather. Any use of similar business data is within the scope of various embodiments.

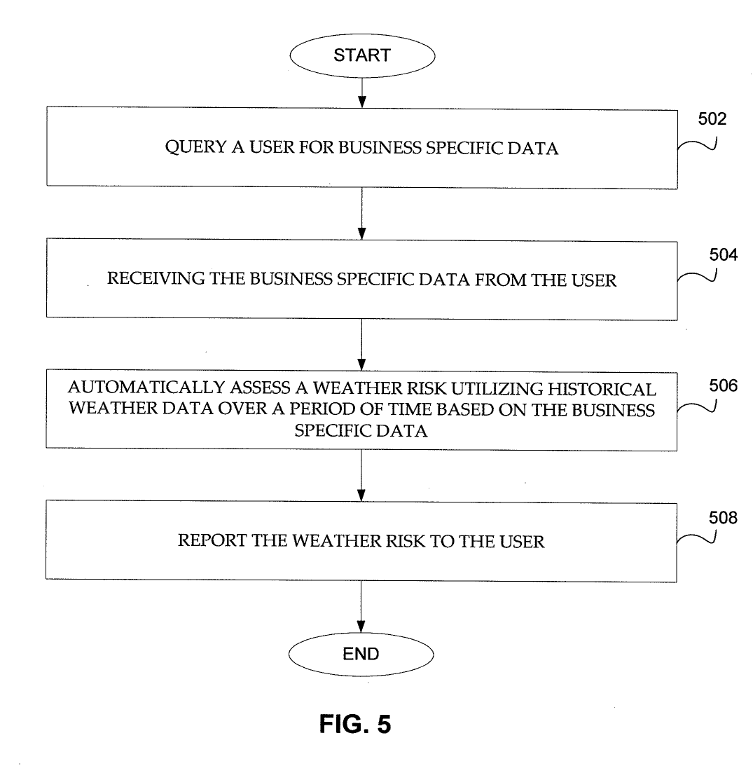

Referring now to FIG. 5 illustrates a flow diagram of an exemplary process for automated risk assessment. At step 502, the user is queried for business specific data, such as the business specific data discussed herein. The business specific data may comprise basic business data, such as industry type, zip code, and average annual revenue. A location for a business may be provided based on the location of the business, a location of a headquarters, or any other location. The business specific data may also comprise data received in response to a questionnaire, a question and answer session, or estimated data provided by the user, as discussed herein. The business specific data may comprise data from an accounting program or financial data generally, according to exemplary embodiments. Any type of business specific data may be provided.

At step 504, the business specific data is received from the user. As discussed herein, the business specific data may be received via the network 104, according to some embodiments. Alternatively, the client device 102 may provide the business specific data directly to the weather risk assessment engine 106. The business specific data may be provided via the mail, telephone, or any other medium according to other embodiments.

At step 506, a weather risk is automatically assessed utilizing historical weather data over a period of time based on the business specific data. As discussed herein, the period of time may be based on the business specific data. For example, if the business specific data for the past three years is provided, the period of time for which the historical weather data 108 is considered may also be for the past three years. According to other embodiments, the period of time for the historical weather data 108 differs from the period of time for which the business specific data is provided.

At step 508, the weather risk is reported to the user. As discussed herein, any type of reporting method or format may be utilized to report the weather risk. According to exemplary embodiments, one or more weather derivative contracts are recommended based on the weather risk assessed.

While various embodiments have been described above, it should be understood that they have been presented by way of example only, and not limitation. For example, any of the elements associated with the weather risk assessment engine 106 may employ any of the desired functionality set forth hereinabove. Thus, the breadth and scope of a preferred embodiment should not be limited by any of the above-described exemplary embodiments.

What is claimed is:

1. A method for automated weather risk assessment, comprising:
querying a user for business specific data;
receiving the business specific data from the user;
automatically assessing a weather risk utilizing historical weather data over a period of time based on the business specific data; and
reporting the weather risk to the user.

2. The method recited in claim 1, further comprising recommending one or more weather derivative contracts based on the weather risk assessed.

3. The method recited in claim 1, wherein the business specific data comprises data from an accounting program.

4. The method recited in claim 1, wherein the business specific data comprises one or more responses to one or more business specific inquiries.

5. The method recited in claim 1, wherein the business specific data comprises basic business data.

6. The method recited in claim 1, wherein the historical weather data comprises weather data from a geographic location consistent with the geographical location of a business associated with the business specific data.

7. The method recited in claim 1, wherein the period of time is based on the business specific data received.

8. A system for automated weather risk assessment, comprising:
a communications interface configured to query a user for business specific data and to receive the business specific data from the user;
a processor configured to automatically assess a weather risk utilizing historical weather data over a period of time based on the business specific data; and
a display configured to report the weather risk to the user.

9. The system recited in claim 8, further comprising recommending one or more weather derivative contracts based on the weather risk assessed.

10. The system recited in claim 8, wherein the business specific data comprises data from an accounting program.

11. The system recited in claim 8, wherein the business specific data comprises one or more responses to one or more business specific inquiries.

12. The system recited in claim 8, wherein the business specific data comprises basic business data.

13. The system recited in claim 8, wherein the historical weather data comprise weather data from a geographic location consistent with the geographical location of a business associated with the business specific data.

14. The system recited in claim 8, wherein the period of time is based on the business specific data received.

15. A computer readable medium having embodied thereon a computer program being executable by a processor for performing a method for automated weather risk assessment, comprising:
querying a user for business specific data;
receiving the business specific data from the user;
automatically assessing a weather risk utilizing historical weather data over a period of time based on the business specific data; and
reporting the weather risk to the user.

16. The computer program recited in claim 15, further comprising recommending one or more weather derivative contracts based on the weather risk assessed.

17. The computer program recited in claim 15, wherein the business specific data comprises data from an accounting program.

18. The computer program recited in claim 15, wherein the business specific data comprises one or more responses to one or more business specific inquiries.

19. The computer program recited in claim 15, wherein the business specific data comprises basic business data.

20. The computer program recited in claim 15, wherein the historical weather data comprise weather data from a geographic location consistent with the geographical location of a business associated with the business specific data.

21. The computer program recited in claim 15, wherein the period of time is based on the business specific data received.
